(19) United States
(12) Patent Application Publication
(10) Pub. No.: US 2026/0222427 A1
(43) Pub. Date: Jul. 30, 2026

(54) SYSTEMS AND METHODS FOR IDENTIFYING NETWORK OPERATIONS THAT ARE INDICATIVE OF AT LEAST ONE CYBERSECURITY EVENT WHEN MONITORING NETWORK ACTIVITY

(71) Applicant: Capital One Services, LLC, McLean, VA (US)

(72) Inventors: Simone Feroce, Cedar Park, TX (US); Kristian Langholm, Cambridge, MA (US); Albert Nabiullin, McLean, VA (US); David Harrington, Pittsburgh, PA (US); Vineet Choudhary, Frisco, TX (US); Sikkandar Sikkandar Packiam, Prosper, TX (US); Raghuram Vijayaraghavan, Prosper, TX (US); Vikas Mummadi, Frisco, TX (US); William Graf, Pasadena, CA (US); Rahul Bhakta, Irving, TX (US); Rais Kazi, Murphy, TX (US)

(73) Assignee: Capital One Services, LLC, McLean, VA (US)

(21) Appl. No.: 19/036,997

(22) Filed: Jan. 24, 2025

(51) Int. Cl. H04L 9/40

(52) U.S. Cl. CPC H04L 63/1425; H04L 63/1416; H04L 63/1441

(57) ABSTRACT

Systems and methods for identifying network operations that are indicative of at least one cybersecurity event when monitoring network activity are disclosed. For example, a system can be configured to contain a data set representing a set of network operations, determine that a subset of network operations from the set of network operations are indicative of irregularities, and generate alert data associated with one or more alerts. In an example, the system can generate a query instruction that is based on the subset of network operations, and provide the query instruction to a database search system to cause the system to generate a set of query results. In this example, the system can update the alert data based on the set of query results.

### BACKGROUND

The complexity of modern software architectures, which often involve numerous interconnected modules, libraries, and dependencies, can complicate the process of identifying and addressing irregularities that arise during normal operation. For example, because irregularities attributable to faults or malicious activity can arise from intricate interactions, it can be difficult to pinpoint the execution of operation(s) that caused such irregularities. And while symptoms of irregularities such as their correlation with certain periods of time, etc., can appear straightforward, understanding the underlying causes of these irregularities involves a thorough analysis of the software architectures and operational data (e.g., logs, etc.), which is time-consuming, resource-intensive, and involves an overly-inclusive group of individuals to due to the often generic symptoms presented by these irregularities.

In one example, failing to identify irregularities indicative of cybersecurity attacks in or near real-time can lead to several significant technical disadvantages that exacerbate the impact of such attacks. One of the primary disadvantages is the extended dwell time of threats within a network, allowing attackers to explore and exploit vulnerabilities over an extended period. This can result in extensive data breaches and system compromises. As the attack progresses undetected, the potential for data loss increases, as attackers may gain access to sensitive information or critical systems, maliciously consume computing resources, and more. Additionally, delayed detection can hinder the system's ability to respond effectively and mitigate the effects of the attack, often resulting in a prolonged recovery process that incurs operational downtime and additional computing resource consumption. Ultimately, not detecting attacks in real-time can undermine a system's overall security posture, making it more vulnerable to future threats.

### SUMMARY

In view of these challenges, systems and methods are described herein relating to novel uses and/or improvements in identifying network operations that are indicative of at least one cybersecurity event when monitoring network activity. More specifically, described are novel techniques for configuring systems to identify irregularities across network operations executed over a period of time and generate targeted alerts in accordance with specific aspects of the irregularities. For example, systems can be configured as described to identify irregularities, generate focused query instructions to obtain relevant query results (as opposed to more generic query instructions that are configured to obtain all possible query results) to use in alerts based on aspects of these irregularities, and target specific downstream systems based on the identified irregularities to receive such alerts, allowing for faster and more succinct alerts that target relevant systems. As a result, relevant information can be obtained and used to generate alerts faster while sparing the over-inclusion of downstream systems in the alerting process that involves unnecessary consumption of network and computing resources. And in the context of cybersecurity attacks, by reducing the dwell time of threats within a system or network, the overall impact of cybersecurity events (e.g., attacks) can be reduced or eliminated as attackers have less (if any) time to explore and exploit vulnerabilities of the targeted system. Further, through faster identification of threats, the chances for data loss, unintentional computing resource consumption, etc., can be reduced as activity attributable to these attackers is more quickly addressed. Additionally, earlier detection can improve the system's ability to respond and recover effectively, often resulting in a faster recovery process and shorter system downtimes.

In some aspects, systems and methods for identifying network operations that are indicative of at least one cybersecurity event when monitoring network activity involving a set of network operations are described. For example, a system can obtain a dataset including a set of network operations. Each network operation can occur at a point in time within a period of time and be represented by one or more attributes. In some examples, the system can determine that a subset of network operations from the set of network operations is indicative of irregularities based on the one or more attributes of each network operation. The system can then generate alert data associated with one or more alerts based on the subset of network operations that are indicative of the irregularities. In some examples, the system can generate a query instruction associated with one or more query criteria based on the subset of network operations. The query instruction can correspond to the irregularities represented by the subset of network operations. The system can then provide the query instruction to a database search system. The query instruction can cause the database search system to generate a set of query results in accordance with the query instruction. In response to obtaining the set of query results from the database search system, the system can update the alert data based on the set of query results. In at least some examples, the system can then generate a graphical user interface (GUI) based on the alert data, the GUI indicating at least one alert of the one or more alerts and at least one query result that corresponds to the at least one alert.

Various other aspects, features, and advantages of the invention will be apparent through the detailed description of the invention and the drawings attached hereto. It is also to be understood that both the foregoing general description and the following detailed description are examples and are not restrictive of the scope of the invention. As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification, “a portion” refers to a part of, or the entirety of (i.e., the entire portion), a given item (e.g., data) unless the context clearly dictates otherwise.

### BRIEF DESCRIPTION OF THE DRAWINGS

FIG. 1 shows an illustrative diagram of an environment for identifying network operations that are indicative of at least one cybersecurity event, in accordance with one or more embodiments.

FIG. 2 shows an illustrative flow diagram of a process for identifying network operations that are indicative of at least one event, in accordance with one or more embodiments.

FIG. 3 shows illustrative components for a system used to identify network operations that are indicative of at least one cybersecurity event, in accordance with one or more embodiments.

FIG. 4 shows a flowchart of the steps involved in a process for identifying network operations that are indicative of at least one cybersecurity event, in accordance with one or more embodiments.

### DETAILED DESCRIPTION OF THE DRAWINGS

In the following description, for the purposes of explanation, numerous specific details are set forth in order to provide a thorough understanding of the embodiments of the invention. It will be appreciated, however, by those having skill in the art that the embodiments of the invention can be practiced without these specific details or with an equivalent arrangement. In other cases, well-known structures and devices are shown in block diagram form in order to avoid unnecessarily obscuring the embodiments of the invention.

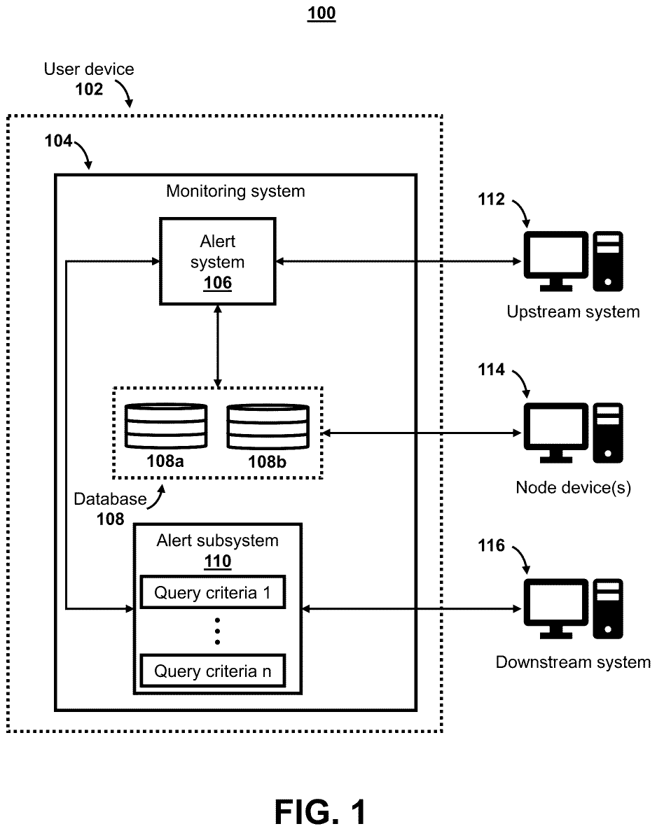

FIG. 1 shows an illustrative diagram of an environment 100 that can be configured to, among other things, identify network operations that are indicative of at least one event (e.g., a cybersecurity event, etc.), in accordance with one or more embodiments. For example, the environment 100 can include a user device 102, an upstream system 112, one or more node devices 114 (referred to individually as a node device 114 and collectively as node devices 114 where contextually appropriate), and a downstream system 116. The user device 102 (e.g., one or more components of the user device 102), the upstream system 112, the node device(s) 114, and/or the downstream system 116 can be configured to interconnect using one or more wired and/or wireless connections. While the environment 100 shows a user device 102, an upstream system 112, a node device 114, and a downstream system 116, environments can include more client devices, upstream systems, node devices, and/or downstream systems that are the same as, or similar to, the user device 102, the upstream system 112, the node device 114, and/or the downstream system 116.

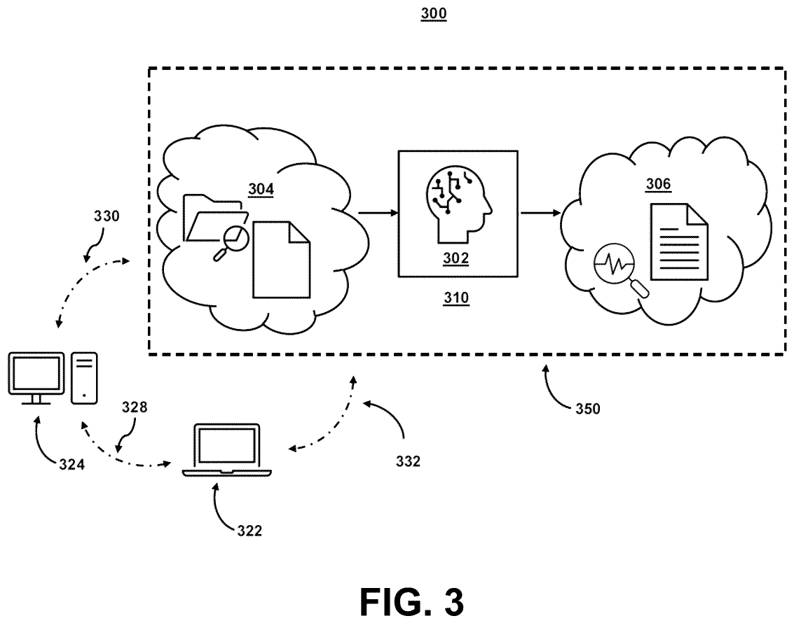

In some embodiments, the user device 102 can include a computing device that is configured to be in communication with the upstream system 112, the node devices 114, and/or the downstream system 116 using one or more communication paths (also referred to as communication connections) as described herein. For example, the user device 102 can include a desktop computer, a laptop computer, a smartphone, a tablet, and/or the like. In some embodiments, the user device 102 can include (e.g., implement) an alert system 106, a database 108, and an alert subsystem 110. The database 108 can include a first dataset 108a and a second dataset 108b that are configured to maintain data generated by computing devices when executed in association with the environment 100. While certain components are illustrated by FIG. 1, the user device 102 can include and/or exclude one or more of the illustrated components. The user device 102 can also include one or more components that are the same as, or similar to, the user terminal 324 of FIG. 3. As described herein, the user device 102 (e.g., one or more components of the user device 102) can establish one or more secured or unsecured communication connections with the upstream system 112, the node devices 114, and/or the downstream system 116.

The upstream system 112, the node devices 114, and the downstream system 116 can include or be formed by one or more computing devices that coordinate execution of one or more operations. For example, the upstream system 112, the node devices 114, and the downstream system 116 can include one or more desktop computers, laptop computers, point-of-sale devices, etc. While illustrated as being independent devices, it will be understood that the upstream system 112, the node devices 114, and the downstream system 116 can be configured to communicate with one another. Additionally, or alternatively, the upstream system 112, the node devices 114, and the downstream system 116 can be implemented by a single computing device (e.g., the user device 102) or within a distributed computing system as separate systems.

In some embodiments, the upstream system 112 can be associated with an analyst (e.g., a change management analyst that is involved in identifying, analyzing, and managing changes identified in time series data, an anomaly detection analyst that is involved in identifying and analyzing unusual patterns or outliers in time series data, etc.), a software developer (e.g., an individual involved in establishing a distributed computing environment to support execution of one or more operations by the node devices 114), etc. As described, the analyst, developer, etc., can interact with the upstream system 112 to configure the monitoring system 104 to generate one or more alerts in response to identification of irregularities (anomalies, changepoints, etc.) represented within time series data stored in the database 108. The analyst can also identify downstream systems (e.g., the downstream system 116) to receive alert data associated with the alerts. For example, the analyst can identify downstream systems that correspond to individuals (e.g., other analysts, developers, etc.) that are tasked with monitoring aspects of the time series data in response to alerts generated by the alert system 106.

In some embodiments, the node devices 114 can include devices involved in executing one or more operations over a period of time that are monitored by the monitoring system 104 (e.g., as specified by the configuration of the monitoring system 104, by the analyst, developer, etc.). For example, the node devices 114 can be associated with devices involves in executing operations within a computer or system architecture and can be implemented by modules executed by an individual device or modules executed by multiple devices in a distributed computing environment. In some examples, the node devices 114 can be associated with one or more client devices (e.g., laptops, desktops, point-of-sale devices, etc.) controlled by individual users (e.g., customers), merchants, acquiring banks, issuing banks, etc.). In examples, the node devices 114 can involve or establish a payment processing network that facilitates electronic transfers of funds between various individuals and/or organizations.

In some embodiments, the downstream system 116 can be associated with one or more analysts, developers, etc., as specified by the upstream system 112 when configuring the monitoring system 104. The downstream system 116 can then obtain data that is provided by the user device 102 such as alert data generated by the monitoring system 104. For example, the downstream system 116 can generate alert data that includes GUI data to be used by the downstream system 116 to generate and display a GUI indicating one or more aspects of the alert generated by the alert system 106.

In some embodiments, the devices of the environment 100 can be configured to establish direct or indirect communication connections between one another. For example, one or more networks can establish communication paths between one or more of the devices of the environment 100 to allow for the communication of messages (e.g., network packets, etc.) therebetween. In this example, the communication paths can be the same as, or similar to, the communication paths 328, 330, and 332 of FIG. 3. The network(s) can include mobile phone networks, mobile voice or data networks, cable networks, public switched telephone networks, the Internet, or other types of communications networks or combinations of communications networks as described herein.

It will be understood that the number and arrangement of devices in the environment 100 are provided as an example and that there can be environments arranged differently than those shown in FIG. 1. In some embodiments, at least some of the device(s) and/or system(s) of FIG. 1 can be implemented by a single device or multiple devices within a distributed system. For example, the user device 102 can be implemented by a single device or as multiple devices that, either alone or in coordination, perform one or more of the operations as described herein.

With continued reference to FIG. 1, one or more of the components of the environment 100 can be configured to identify network operations that are indicative of at least one cybersecurity event when monitoring network activity. For example, the user device 102 can be configured to obtain a dataset including a set of network operations store the dataset in one or more databases 108a, 108b of the database 108. The user device 102 can obtain the dataset (e.g., including event data associated with at least one cybersecurity event) based on (e.g., in response to) the user device 102 monitoring network operations that are performed by the node devices 114. In one example, the node devices 114 can establish communication paths with one another and execute network operations that are coordinated in accordance with a workflow. As instances of the workflow are executed, the node devices 114 can generate and provide data to the user device 102 representing the network operations performed by the respective node devices 114. In one example, the data can include transaction data associated with one or more network operations that, alone or in combination, represent the coordinated execution of a transaction by the node devices 114. These transactions can include interactions with one or more web servers when accessing resources associated with one or more websites, payment transactions, etc. It will be understood that a given network operation can be represented by data generated by a single node device 114 or multiple node devices 114.

In some embodiments, the data received in response to execution of the network operations can further include metadata. The metadata can include metadata elements that represent aspects of the data generated by the node devices 114. In some embodiments, the metadata elements can be used to organize the network operations. For example, the metadata elements can be used to organize the network operations by party names (e.g., individuals or organizations involved in a transaction), device identifiers (e.g., indicated by payment devices, etc. involved in a given network operation), dates, file sizes, amounts involved, account numbers, etc. In the context of payment processing, the metadata elements can be used by the user device 102 to organize the network operations according to attributes represented by the transactions for later processing. This later processing can include, for example, the detection of irregularities such as anomalies, changepoints, etc. across a plurality of network operations during a period of time. The metadata elements can also be used by the alert system 106 to generate alert data for downstream systems, including the downstream system 116, based on the individual(s) using the downstream systems.

In some embodiments, the data received in response to execution of the network operations by the node devices 114 can be generated during a specific period of time. For example, the data can be generated during a period of time where points in time within the period of time correspond to respective network operations having been executed by the node devices 114. The monitoring system 104 can then analyze the network operations to identify irregularities such as changepoints, anomalies, etc. in view of the other network operations executed during the period of time. As will be understood, the monitoring system 104 can periodically or continuously analyze the network operations in response to receiving data associated with individual network operations, groups of network operations, etc.

In at least some examples described herein, a changepoint can include a specific point in time where the underlying probability distribution of the data stored in dataset changes. The changepoint can represent a significant shift in the statistical properties of the data, such as mean, variance, or trend. In some examples, changepoints can divide a timeseries of data in the dataset into segments with distinct statistical characteristics, allowing for the identification of important transitions or events within the data (e.g., the point at which a cybersecurity event such as a distributed denial of service DDoS attack was initiated, the point at which one or more changes in network traffic occurred, such as visits to a particular webpage of a merchant, etc.). The changepoints can then be used by the alert system 106 to generate one or more alerts indicative of structural changes in the dataset during the period of time. Similarly, in at least some examples described herein, an anomaly can include a deviation from an expected norm, pattern, or rule. For example, an anomaly can refer to one or more attributes of one or more network operations that are unusual, irregular, or inconsistent with the other network operations in the dataset. In some examples, anomalies can indicate errors, unique events, or important insights, depending on the context, and their identification can be used to detect problems (e.g., cybersecurity attacks), or discovering phenomena (e.g., trends) represented by the network operations.

In some embodiments, the user device 102 can cause the monitoring system 104 to determine that a subset of network operations from the set of network operations are indicative of irregularities. For example, the monitoring system 104 can analyze the data in the database 108 in response to aggregation of the data over a period of time. The monitoring system 104 can then identify irregularities based on an analysis of the one or more attributes of each network operation in the database 108. For example, the monitoring system 104 can analyze the network operations received over a period of time and determine that a subset (e.g., one or more) of the network operations in the dataset are associated with irregularities including changepoints or anomalies.

In some embodiments, the monitoring system 104 can be configured by a user such as an analyst, developer, etc., to analyze the dataset in the database 108 and identify the irregularities represented in network operations over a period of time. For example, the user device 102 can receive data generated in response to input (e.g., first user input) by the analyst, developer, etc. at the upstream system 112 to configure the monitoring system 104. The first user input can be indicative of one or more conditions that are associated with the irregularities to be identified when monitoring network operations performed by node devices 114. These conditions can represent statistical thresholds (e.g., deviations from mean or variance), pattern changes in timeseries data, deviations from predefined rules or expected relationships, contextual inconsistencies, or deviations from learned normal behavior using machine learning models (e.g., machine learning models that are trained to identify changepoints, anomalies, etc.). In response to receiving the first user input, the monitoring system 104 can be configured to periodically or continuously analyze network operations represented by data stored in the database 108 and segment the network operations that are associated with irregularities (e.g., as a subset of network operations) from the network operations that are not associated with irregularities.

Additionally, or alternatively, the monitoring system 104 can be configured by a user interacting with the upstream system 112 to generate alert data for alerts that target downstream systems 116. For example, the user can provide inputs to the upstream system 112 when configuring one or more query criteria. The query criteria can be maintained in the alert subsystem 110. In some examples, the query criteria can specify the downstream system 116 as being targeted to receive alerts generated by the alert system 106 from among a plurality of downstream systems (not explicitly illustrated). In some examples, the query criteria can specify downstream systems (including the downstream system 116 or other similar systems) that are correlated with specific individuals designated to address specific types of irregularities as represented through combinations of anomalies or changepoints.

In some embodiments, the monitoring system 104 can compare the conditions associated with the irregularities to the one or more attributes of the network operations stored in the database 108 and determine that the subset of network operations are indicative of irregularities. For example, the monitoring system 104 can compare a condition of the plurality of conditions to one or more attributes of each network operation of the set of network operations stored in the database 108. In examples where the monitoring system 104 determines that the one or more attributes of a given network operation satisfies the condition, the monitoring system 104 can determine that the at least one network operation is indicative of an irregularity such as a changepoint, an anomaly, etc. In examples where the monitoring system 104 determines that the one or more attributes of a given network operation does not satisfy the condition, the monitoring system 104 can determine that the at least one network operation is not indicative of an irregularity.

In one example, the monitoring system 104 can compare the conditions associated with irregularities indicative of changepoints to the network operations stored in the database 108 and identify a subset of network operations that correspond to points in time representing such changepoints. In this example, the monitoring system 104 can identify the downstream system 116 as designated to receive an alert in response to the identification of the changepoints. The monitoring system 104 can then cause the alert system 106 to generate one or more alerts in accordance with the query criteria stored in the alert subsystem 110 and generate alert data based on these alerts, as described herein.

In another example, the monitoring system 104 can compare the conditions associated with irregularities indicative of anomalies to the network operations stored in the database 108 and identify a subset of network operations that are anomalous. In this example, the monitoring system 104 can identify the downstream system 116 as designated to receive an alert indicative of the occurrence of the anomalous network operations. The monitoring system 104 can then cause the alert system 106 to generate one or more alerts in accordance with the query criteria corresponding to the identified anomalous network operations and generate alert data based on these alerts, as described herein.

In some embodiments, the monitoring system 104 can use a machine learning model to identify irregularities within the network operations stored in the database 108. For example, the monitoring system 104 can provide the data associated with the network operations and/or portions of the metadata elements associated with the network operations stored in the database 108 to a machine learning model, causing the model to generate an output. In this example, the machine learning model can be configured to generate an output indicative of whether corresponding network operations of the set of network operations are associated with changepoints or anomalous network operations. In one example, the output can include a probability that the network operations are associated with the changepoints and/or anomalies. In another example, the output can include a binary indication (e.g., yes or no) that the network operations are or are not associated with the changepoints or anomalies. The monitoring system 104 can then determine the subset of network operations that are indicative of irregularities (changepoints and/or anomalies) based on the output of the machine learning model or models described herein. In some examples, the output of the machine learning model can include annotations that the alert system 106 can use to annotate the subset of network operations that are indicative of anomalies and/or changepoints.

In some embodiments, the machine learning model described above can be trained to detect anomalies or changepoints in the timeseries of network operations by learning patterns of normal behavior across a plurality of network operations and identifying deviations. For example, the machine learning model can include an autoencoder that is configured to reconstruct datasets managed by the database 108 and flag instances with high reconstruction errors as anomalies. Additionally, or alternatively, supervised approaches like classification models can be used if labeled (e.g., annotated) data is available. The machine learning model can incorporate features such as statistical properties (mean, variance), temporal patterns, and domain-specific metrics. During inference, the machine learning model can analyze the data stored in the database 108 representing the network operations over the period of time and compare them to learned normal patterns and flagging significant deviations as potential anomalies or changepoints. This approach allows for automated, real-time detection of irregular network behavior that can indicate cybersecurity events, changes in trends, etc.

In some embodiments, the monitoring system 104 can cause the alert system 106 to generate alert data that is based on at least one network operation of the subset of network operations. For example, the monitoring system 104 can cause the alert system 106 to generate alert data in response to identifying the subset of network operations that are indicative of irregularities. In this example, the alert data can be associated with one or more indicators that specify the network operations and/or aspects of the network operations that indicative of the irregularities. These indicators can include points in time at which the network operations were executed, identifiers of the network operations (e.g., transaction identifiers, etc.), node devices 114 that were involved in the network operations, etc. In some embodiments, the indicators can be based on the network operations and/or the metadata representing the network operations as described herein.

In some embodiments, the alert system 106 can generate the alert data based on instructions that configure the alert system 106 to obtain a set of metadata elements for each network operation when generating the alert data. For example, the user device 102 can receive data generated in response to input (e.g., second user input) by the analyst, developer, etc., at the upstream system 112 to configure the monitoring system 104 to generate alert data in response to the identification of irregularities. In this example, the user device 102 can configure the alert system 106 to generate query instructions that, when provided for execution by a database search system of the database 108, return a set of metadata elements when a particular type of irregularity is identified. The database can then persist the data using a database search system such as ElasticSearch® search engine or Postgres® search engine. The database 108 can then receive one or more query instructions and execute cause the database search system to scan the databases 108a, 108b (or external databases that are not explicitly illustrated) and identify relevant network operations and/or corresponding metadata elements. For example, the alert system 106 can communicate with the alert subsystem 110 to generate the query instruction based on (e.g., in accordance with) the second user input. In this example, the query instruction can be configured to cause the database search system implemented by the database 108 to generate the set of query results and include specified metadata elements for each network operation that are indicative of the irregularities in accordance with the one or more query criteria. The database 108 can then return the data identified as responsive to the query instruction to the alert system 106, and the alert system 106 can include the data when generating the alert data for the downstream system 116.

In some embodiments, the query instruction can be generated based on one or more aspects of the subset of network operations that include irregularities determined from among the set of network operations. For example, the query instruction can identify relevant data and/or metadata for a particular type of irregularity of the subset of network operations that include irregularities. In one example, where irregularities are associated with network operations executed in a particular geographic region, the query instruction can be generated based on query criteria for that region that identifies relevant databases assigned to manage data generated within that geographic region. As a result, query instruction can cause one or more database search systems to return data responsive to the query that is localized to that particular geographic region. And in some examples, the quick criteria can also specify one or more downstream systems (including the downstream system 116) that are to receive data associated with the resulting query results. For example, where the downstream system 116 is similarly associated with a particular geographic region where the subset of network operations that include irregularities are executed, the query instruction can be generated based on query criteria indicating the downstream system 116 from among a plurality of downstream systems. In this way, the query instructions can be generated and used to execute queries that are tailored for the specific irregularities identified across the subset of network operations, allowing for a more focused search for relevant data and metadata to be used to generate and/or update the alert data that is generated based on these irregularities. This, in turn, can result in the faster execution of the query instruction, reduced communication between devices involved in executing the query instruction, and reduction in computing resource consumption that would be involved in obtaining all of the data represented by this subset of network operations.

In some examples, the alert system 106 can provide the query instruction to the database 108 and cause the database search system to generate one or more secondary query instructions. The secondary query instructions can be configured to cause internal databases (e.g., databases 108a, 108b) and/or external databases (not explicitly illustrated) to obtain and include query results including metadata elements in accordance with compatibility standards for the various databases. The database 108 can then cause the database search system to execute the one or more secondary query instructions in accordance with the compatibility standards for each database. For example, the database search system can provide the secondary query instruction to the one or more external database systems to cause the external database systems to search the data maintained by such systems. The secondary query instruction can then cause the database systems to generate query results in accordance with the query instruction as represented by the secondary query instruction (that is compatible with the external database systems). In response to obtaining the query results, the alert system 106 can include the query results in the alert data to be provided to the downstream system 116.

In one example, where the alert system 106 is generating query instructions to obtain metadata elements for network operations identified as irregular, the alert system 106 can determine that a first external database and a second external database to be queried that are known to be maintained in accordance with different compatibility standards. In this example, these first and second external databases can be configured to operate under the different compatibility standards, allowing for flexibility in system integration. This configuration can be managed through compatibility levels or modes, which determine how the database behaves and the features that are available. In one example, in SQL Server, administrators can set specific compatibility levels for databases, enabling them to mimic the behavior of earlier versions while running on newer server versions. Similarly, other database management systems can offer compatibility settings that allow databases to function according to different standards or versions. These configurations can affect query processing, syntax support, and feature availability, ensuring that applications designed for specific database versions or standards can operate correctly even when the underlying database system has been upgraded. By causing the database search system to generate query instructions in accordance with the compatibility standards of each database, the alert system 106 can obtain relevant metadata elements from disparate systems and obtain greater amounts of information that can explain the reasons for the irregularities than would be otherwise attainable when generating alerts as described herein.

In some embodiments, the alert system 106 can generate alert data based on a configuration of the downstream system 116. For example, the downstream system 116 can be associated with a configuration (initially specified by the upstream system 112) that indicates one or one or more aspects of the network operations and/or one or more metadata elements to include when alerting the downstream system 116 to irregularities in the network operations. In examples, the upstream system 112 can specify one or more aspects and/or one or more metadata elements for each downstream system (including the downstream system 116) that is to be alerted when irregularities are identified by the monitoring system 104.

In some embodiments, the alert system 106 can determine that the downstream system 116 is associated with a particular individual that is tasked with monitoring and responding to certain types of irregularities such as certain types of changepoints, certain types of anomalies, etc. In this example, the alert system 106 can extract information from a subset of the alert data that corresponds to a configuration of the downstream system 116 (e.g., a client device, etc.) when generating the alert data and/or updating the alert data for the downstream system 116. To extract the information corresponding to the configuration of the downstream system 116, the alert system 106 can determine one or more filter parameters indicated by the configuration of the downstream system 116 (specified by the input received at the upstream system 112). The filter parameters can indicate, for example, metadata elements of irregular network operations that the individual controlling the downstream system 116 is designated to monitor and address. The alert system 106 can then segment network operations from the subset of network operations based on the filter parameters to generate and/or update the alert data targeted to the downstream system 116.

In one example, the alert system 106 can segment network operations to determine a group of network operations. The group of network operations can include at least one network operation that is indicative of the irregularities and one or more additional network operations. For example, where a changepoint or an anomaly is associated with a given network operation, the alert system 106 can identify the given network operation and one or more network operations executed at points in time before or after the given network operation. In this way the alert system 106 can generate alert data that includes network operations that, while not necessarily identified as being irregular, can be associated with the irregular network operations.

In another example, the alert system 106 can segment the network operations by applying filter parameters for the downstream system 116. The filter parameters can include, for example, geographic parameters indicative of one or more geographic boundaries. In the context of network operations that represent payment transactions performed in physical locations (e.g., at point of sale devices), the filter parameters can indicate one or more areas (e.g., geographic areas such as towns, counties, states, countries, etc.) according to which alerts are to be generated for the downstream system 116. In this way, the alert system 106 can segment the network operations for downstream systems that correspond to respective geographic areas such that the downstream system 116 only receives alerts for irregular network operations within the geographic area assigned to the downstream system 116. This, in turn, can reduce the chances of excessive alerts being provided to the downstream system 116 and allow for the tailored generation of alert data for the downstream system 116. Additionally, or alternatively, the filter parameters can include value parameters indicative of values associated with the network operations that are identified as being irregular. For example, the filter parameters can include value parameters that specify a threshold amount according to which alerts should or should not be generated. In this example, the downstream system 116 can be targeted with alerts for network operations that are associated with high-value transactions (e.g., in the case where there is a sudden increase in network operations involving high value transactions as opposed to a sudden increase in network operations that involve comparatively lower value transactions).

In some embodiments, in response to obtaining the set of query results from the database search system, the alert system 106 can update the alert data based on the set of query results. For example, the alert system 106 can include data representing the network operations and/or the metadata elements for the network operations and the alert data designated for the downstream system 116. Additionally, or alternatively, the alert system 106 can update the alert data based on the segmentation of the network operations as described above. For example, the alert system 106 can update the alert data such that network operations corresponding to the downstream system 116 and not other downstream systems can be included in the alert data and provided to the downstream system 116. This, in turn, can cause the downstream system 116 to generate an output indicative of the alert.

For example, where the alert system 106 generates a graphical user interface (GUI) based on the alert data, the alert data can be configured to cause a display device or any other suitable output device of the downstream system 116 to output the GUI. The GUI can indicate at least one alert of the one or more alerts and at least one query result that corresponds to the at least one alert. For example, the GUI can include a visual representation of one or more network operations that are identified as including irregularities whereas being associated with network operations that include irregularities. This visual representation can also include a representation of the metadata elements associated with the network operations involved in the alert.

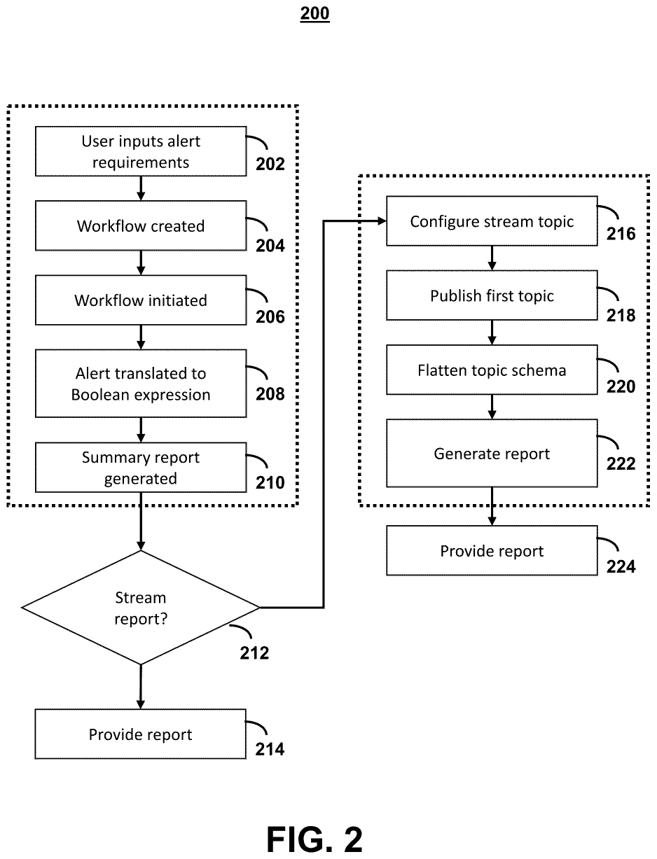

FIG. 2 shows an illustrative flow diagram of a process 200 for identifying network operations that are indicative of at least one event, in accordance with one or more embodiments. In examples, one or more aspects described with respect to the process 200 can be performed by a user device that is the same as, or similar to, the user device 102 of FIG. 1. In some examples, one or more aspects to described with respect to the process 200 can be performed by a device independent of or in coordination with the user device, such as an upstream system (e.g., that is the same as, or similar to, the upstream system 112 of FIG. 1), one or more node devices (e.g., that are the same as, or similar to, the node device 114 of FIG. 1), and/or a downstream system (e.g., that is the same as, or similar to, the downstream system 116 of FIG. 1).

At operation 202, a user can input alert requirements that are used to generate alert data in response to the identification of irregularities within network operations stored in a database. For example, a user can input alert requirements such as a threshold value indicative of a transaction price, a transaction volume, etc. The input can be submitted via a form that causes an alert system as described herein to automatically monitor the requirements included in the input query. The user can input the alert requirements into an upstream system that is configured to communicate with a user device when analyzing a dataset of network operations to identify irregularities over time. The alert requirements can then be used to configure the user device to monitor and filter network operations identified as irregular (e.g., indicative of anomalies, changepoints, etc.) in accordance with the alert requirements. Additionally, or alternatively, the alert requirements can specify one or more downstream systems that are configured to receive alerts in response to the identification of irregularities that satisfy the alert requirements in network operations monitored by the user device.

At operation 204, a workflow can be created by the user device that is triggered in response to the detection of irregular network operations (e.g., using Kubernetes, cloud compute, etc.). For example, the user device can be configured to implement a monitoring system (e.g., similar to the monitoring system 104 of FIG. 1) in accordance with the alert requirements described above. At operation 206, in response to the identification of network operations as indicative of irregularities, the workflow can be initiated to generate alerts, including a report that is to be provided to one or more downstream systems. During execution of the workflow, the user device can generate query instructions associated with alerts targeting the downstream systems and provide the query instructions to databases, causing the databases to pull and return relevant data (including relevant metadata elements). For example, at operation 208, the user device can translate query criteria into one or more query instructions representing Boolean expressions that can be used to obtain data associated with various network operations and corresponding metadata elements when generating alerts targeting downstream systems. In an example, the user device can translate an alert into a Boolean expression that defines the conditions that trigger the alert as a logical statement that evaluates to true or false. This process uses logical operators (AND, OR, NOT) and comparison operators (>, <, =) to combine thresholds or criteria based on metrics or data points. For example, an alert for anomaly detection might be expressed as (value>upper threshold OR value<lower threshold) AND (anomaly score>alert threshold). The expression evaluates to true when the conditions are met, triggering the alert. This approach allows for precise, automated evaluation of data streams for real-time monitoring and anomaly detection.

At operation 210, the user device can generate a summary report represented as, for example, a graphical user interface (GUI). This summary report can then be provided to a downstream system configured to receive the summary report and generate a GUI. At operation 212, the user device can determine whether or not to stream the summary report directly to the downstream system configured to receive the report. In some examples where the report is being streamed to a predetermined set of downstream systems, at operation 214, the user device can provide the report to the downstream systems.

At operation 216, the user device can be configured to stream a topic. For example, the user device can be configured to monitor specific network operations and generate alerts based on predefined criteria. The configuration process can involve defining the parameters and conditions that trigger alerts, such as identifying anomalies or changepoints that occur as a result of cybersecurity attacks, sudden shifts in network activity (e.g., visits to a particular website for a product hosted for a merchant), sudden shifts in purchasing activity at one or more stores, in one or more geographic locations, etc., in the network operations. Once the criteria are established, the user device can create a workflow that initiates the generation of alerts when these conditions are met. The alerts can then be compiled into a summary report, which is formatted as a GUI for ease of interpretation. This GUI can be streamed directly to the downstream system, ensuring that relevant individuals operating the downstream systems receive timely and actionable information about the identified irregularities.

At operation 218, the user device can be configured to publish a first topic (e.g., the Kafka® event streaming platform by establishing a communication connection with one or more downstream systems (e.g., using a delivery bus). This process can involve selecting the relevant network operations, formatting the network operations according to predefined criteria established based on input from the upstream system, and then transmitting data associated with the network operations to the downstream system(s). The user device can confirm that the data meets the necessary security and compliance standards before publication. Once the topic is published (e.g., to a downstream system (also referred to as a “sink” such as a system or repository managed by, e.g., Salesforce®), it becomes accessible to authorized downstream systems, who can then monitor and analyze the information in real-time. This capability can improve the ability to respond swiftly to network irregularities and maintain operational integrity.

At operation 220, the user device can flatten a topic schema to optimize the storage and retrieval of data associated with the network operations identified as irregular, including metadata elements associated with the network operations. Flattening a topic schema can involve transforming complex, hierarchical data structures into simpler, tabular formats, which can enhance query performance and data processing efficiency. By reducing the depth of nested schemas, the user device can minimize the complexity of data handling and ensure that the data is more easily accessible for analysis and reporting. This streamlined approach can allow for more straightforward integration with downstream systems, as the flattened schema provides a uniform data structure that can be universally understood and utilized across various platforms.

At operation 222, the user device can generate a report by compiling the relevant data. This can involve aggregating data (including metadata elements) associated with the network operations, applying any necessary filters or transformations for the targeted downstream systems, and presenting the information in a clear and organized manner. The report can include visualizations such as charts, graphs, and tables to effectively convey the insights derived from the data. Once generated, the report can be distributed to the appropriate downstream systems to deliver critical information. Similar to operation 214, at operation 224, the user device can provide the report to the downstream systems targeted to receive the report.

FIG. 3 shows illustrative components for a system used to identify network operations that are indicative of at least one cybersecurity events, in accordance with one or more embodiments. As shown in FIG. 3, system 300 can include mobile device 322 and user terminal 324. While shown as a smartphone and personal computer, respectively, in FIG. 3, it should be noted that mobile device 322 and user terminal 324 can be any computing device, including, but not limited to, a laptop computer, a tablet computer, a hand-held computer, and other computer equipment (e.g., a server), including “smart,” wireless, wearable, and/or mobile devices. FIG. 3 also includes cloud components 310. Cloud components 310 can alternatively be any computing device as described above and can include any type of mobile terminal, fixed terminal, or other device. For example, cloud components 310 can be implemented as a cloud computing system and can feature one or more component devices. It should also be noted that system 300 is not limited to three devices. Users can, for instance, utilize one or more devices to interact with one another, one or more servers, or other components of system 300. It should be noted that, while one or more operations are described herein as being performed by particular components of system 300, these operations can, in some embodiments, be performed by other components of system 300. As an example, while one or more operations are described herein as being performed by components of mobile device 322, these operations can, in some embodiments, be performed by components of cloud components 310. In some embodiments, the various computers and systems described herein can include one or more computing devices that are programmed to perform the described functions. Additionally, or alternatively, multiple users can interact with system 300 and/or one or more components of system 300. For example, in one embodiment, a first user and a second user can interact with system 300 using two different components.

With respect to the components of mobile device 322, user terminal 324, and cloud components 310, each of these devices can receive content and data via input/output (hereinafter “I/O”) paths. Each of these devices can also include processors and/or control circuitry to send and receive commands, requests, and other suitable data using the I/O paths. The control circuitry can comprise any suitable processing, storage, and/or input/output circuitry. Each of these devices can also include a user input interface and/or user output interface (e.g., a display) for use in receiving and displaying data. For example, as shown in FIG. 3, both mobile device 322 and user terminal 324 include a display upon which to display data (e.g., conversational response, queries, and/or notifications).

Additionally, as mobile device 322 and user terminal 324 are shown as touchscreen smartphones, these displays also act as user input interfaces. It should be noted that in some embodiments, the devices can have neither user input interfaces nor displays and can instead receive and display content using another device (e.g., a dedicated display device such as a computer screen and/or a dedicated input device such as a remote control, mouse, voice input, etc.). Additionally, the devices in system 300 can run an application (or another suitable program). The application can cause the processors and/or control circuitry to perform operations related to generating dynamic conversational replies, queries, and/or notifications.

Each of these devices can also include electronic storages. The electronic storages can include non-transitory storage media that electronically store information. The electronic storage media of the electronic storages can include one or both of (i) system storage that is provided integrally (e.g., substantially non-removable) with servers or client devices, or (ii) removable storage that is removably connectable to the servers or client devices via, for example, a port (e.g., a USB port, a firewire port, etc.) or a drive (e.g., a disk drive, etc.). The electronic storages can include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storages can include one or more virtual storage resources (e.g., cloud storage, a virtual private network, and/or other virtual storage resources). The electronic storages can store software algorithms, information determined by the processors, information obtained from servers, information obtained from client devices, or other information that enables the functionality as described herein.

FIG. 3 also includes communication paths 328, 330, and 332. Communication paths 328, 330, and 332 can include the Internet, a mobile phone network, a mobile voice or data network (e.g., a 5G or LTE network), a cable network, a public switched telephone network, or other types of communication networks or combination of communication networks. Communication paths 328, 330, and 332 can separately or together include one or more communication paths, such as a satellite path, a fiber-optic path, a cable path, a path that supports Internet communications (e.g., IPTV), free-space connections (e.g., for broadcast or other wireless signals), or any other suitable wired or wireless communication paths or combination of such paths. The computing devices can include additional communication paths linking a plurality of hardware, software, and/or firmware components operating together. For example, the computing devices can be implemented by a cloud of computing platforms operating together as the computing devices.

Cloud components 310 can include model 302, which can be a machine learning model, an artificial intelligence model, etc. (which can be referred to collectively as “models” herein). Model 302 can take inputs 304 and provide outputs 306. The inputs can include multiple datasets, such as a training dataset and a test dataset. Each of the plurality of datasets (e.g., inputs 304) can include data subsets related to user data, predicted forecasts and/or errors, and/or actual forecasts and/or errors. In some embodiments, outputs 306 can be fed back to model 302 as input to train the model 302 (e.g., alone or in conjunction with user indications of the accuracy of outputs 306, labels associated with the inputs, or with other reference feedback information). For example, the system can receive a first labeled feature input, wherein the first labeled feature input is labeled with a known prediction for the first labeled feature input. The system can then train the first machine learning model to classify the first labeled feature input with the known prediction (e.g., an action graph, a graph characteristic, a graph value, an objective, etc.).

In a variety of embodiments, model 302 can update its configurations (e.g., weights, biases, or other parameters) based on the assessment of its prediction (e.g., outputs 306) and reference feedback information (e.g., user indication of accuracy, reference labels, or other information). In a variety of embodiments, where model 302 is a neural network, connection weights can be adjusted to reconcile differences between the neural network's prediction and reference feedback. In a further use case, one or more neurons (or nodes) of the neural network can require that their respective errors be sent backward through the neural network to facilitate the update process (e.g., backpropagation of error). Updates to the connection weights can, for example, be reflective of the magnitude of error propagated backward after a forward pass has been completed. In this way, for example, the model 302 can be trained to generate better predictions.

In some embodiments, model 302 can include an artificial neural network. In such embodiments, model 302 can include an input layer and one or more hidden layers. Each neural unit of model 302 can be connected with many other neural units of model 302. Such connections can be enforcing or inhibitory in their effect on the activation state of connected neural units. In some embodiments, each individual neural unit can have a summation function that combines the values of all of its inputs. In some embodiments, each connection (or the neural unit itself) can have a threshold function such that the signal must surpass it before it propagates to other neural units. Model 302 can be self-learning and trained, rather than explicitly programmed, and can perform significantly better in certain areas of problem solving as compared to traditional computer programs. During training, an output layer of model 302 can correspond to a classification of model 302, and an input known to correspond to that classification can be input into an input layer of model 302 during training. During testing, an input without a known classification can be input into the input layer, and a determined classification can be output.

In some embodiments, model 302 can include multiple layers (e.g., where a signal path traverses from front layers to back layers). In some embodiments, back propagation techniques can be utilized by model 302, where forward stimulation is used to reset weights on the “front” neural units. In some embodiments, stimulation and inhibition for model 302 can be more free-flowing, with connections interacting in a more chaotic and complex fashion. During testing, an output layer of model 302 can indicate whether or not a given input corresponds to a classification of model 302 (e.g., an action graph, a graph characteristic, a graph value, an objective, etc.).

In some embodiments, the model (e.g., model 302) can automatically perform actions based on outputs 306. In some embodiments, the model (e.g., model 302) can not perform any actions. The output of the model (e.g., model 302) can be used to generate a response in a user interface.

System 300 also includes API layer 350. API layer 350 can allow the system to generate summaries across different devices. In some embodiments, API layer 350 can be implemented on mobile device 322 or user terminal 324. Alternatively, or additionally, API layer 350 can reside on one or more of cloud components 310. API layer 350 (which can be a REST or Web services API layer) can provide a decoupled interface to data and/or functionality of one or more applications. API layer 350 can provide a common, language-agnostic way of interacting with an application. Web services APIs offer a well-defined contract, called WSDL, that describes the services in terms of their operations and the data types used to exchange information. REST APIs do not typically have this contract; instead, they are documented with client libraries for most common languages, including Ruby, Java, PHP, and JavaScript. SOAP Web services have traditionally been adopted in the enterprise for publishing internal services as well as for exchanging information with partners in B2B transactions.

API layer 350 can use various architectural arrangements. For example, system 300 can be partially based on API layer 350, such that there is strong adoption of SOAP and RESTful Web services, using resources like Service Repository and Developer Portal, but with low governance, standardization, and separation of concerns. Alternatively, system 300 can be fully based on API layer 350, such that separation of concerns between layers like API layer 350, services, and applications are in place.

In some embodiments, the system architecture can use a microservice approach. Such systems can use two types of layers: Front-End Layer and Back-End Layer, where microservices reside. In this kind of architecture, the role of the API layer 350 can provide integration between Front-End and Back-End. In such cases, API layer 350 can use RESTful APIs (exposition to front-end or even communication between microservices). API layer 350 can use AMQP (e.g., Kafka, RabbitMQ, etc.). API layer 350 can use incipient usage of new communications protocols such as gRPC, Thrift, etc.

In some embodiments, the system architecture can use an open API approach. In such cases, API layer 350 can use commercial or open-source API Platforms and their modules. API layer 350 can use a developer portal. API layer 350 can use strong security constraints by applying WAF and DDoS protection, and API layer 350 can use RESTful APIs as standard for external integration.

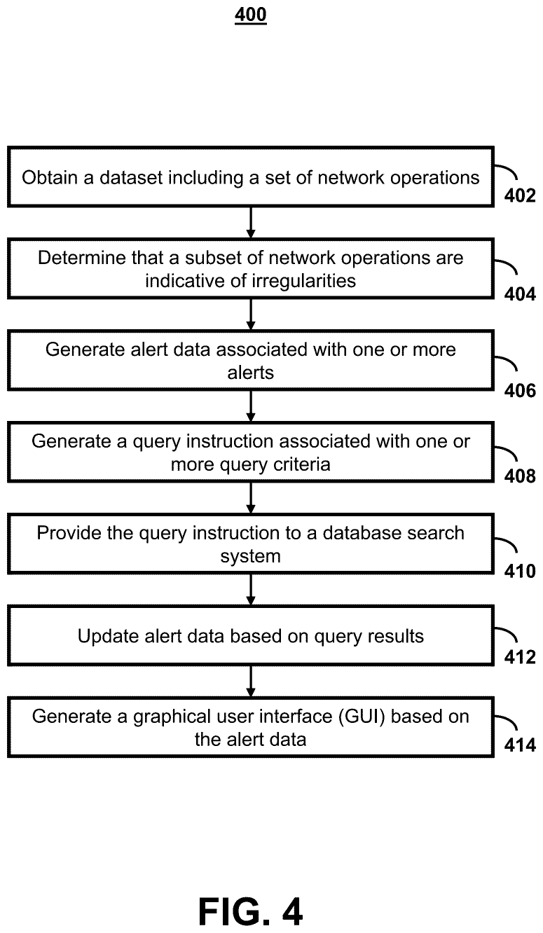

FIG. 4 shows a flowchart of the steps involved in a process 400 for identifying network operations that are indicative of at least one cybersecurity event in accordance with one or more embodiments. For example, a system that is the same as (or similar to) one or more of the systems illustrated in FIG. 1 (e.g., the user device 102 of FIG. 1, etc.) can implement at least a portion of the process 400 described herein.

At operation 402, the process 400 can include obtaining a dataset including a set of network operations. For example, a user device can be configured to obtain data, either periodically or continuously, from node devices during execution of one or more network operations over a period of time. The user device can then store the data associated with the one or more network operations in a database and periodically or continuously analyze the data stored in the database to identify irregularities within the network operations as described herein.

At operation 404, the process 400 can include determining that a subset of network operations are indicative of irregularities. For example, the user device can execute one or more operations to determine whether or not network operations monitored over a period of time are indicative of irregularities. These irregularities can be associated with changepoints, anomalies, etc. The user device can also annotate each network operation of the subset of network operations as being indicative of the irregularities. For example, the user device can annotate each network operation identified as being indicative of a changepoint, an anomaly, and/or combinations thereof.

At operation 406, the process 400 can include generating alert data associated with one or more alerts. For example, the user device can generate alert data in response to the generation of one or more alerts for one or more downstream systems targeted to receive the alerts. In one example, the user device can generate alerts for a downstream system that is configured to monitor and address irregularities within a particular geographic region, within a particular set of node devices, etc. The alert data can be based on the network operations, the metadata elements representing the network operations accessible by the user device, etc.

At operation 408, the process 400 can include generating a query instruction associated with one or more query criteria. For example, in response to the generation of one or more alerts targeting a downstream system, the user device can extract and generate a query instruction based on at least one metadata element associated with the subset of network operations. The at least one metadata element can be represented by the query instruction, which is to be provided to one or more databases (e.g., a .CSV file, etc.). In some examples, the query instruction can include one or more query criteria that can be associated with columns that include data to be returned and used when generating an alert. The query instruction can be configured to cause the databases to search datasets stored therein and return portions of the dataset that are responsive to the query instruction. In one example, where a downstream system is configured to receive alerts within a predetermined geographic area, the query instruction can be configured to cause the databases to return portions of the datasets representing network operations that are executed within that geographic area (e.g., by point of sale devices within that geographic area). In another example, where a downstream system is configured to receive alerts for a particular set of node devices (e.g., associated with a particular merchant, customer, acquiring bank, issuing bank, etc.), query instruction can be configured to cause the database to return portions of the datasets representing network operations involving these particular node devices.

At operation 410, the process 400 can include providing the query instruction to a database search system. For example, the user device can provide the query instruction to a database search system implemented by a database that is managed or accessible by the user device. In another example, the user device can provide the query instruction to database search system of a remote database that is in communication with the user device. In some examples, the query instruction can be updated to be compatible with one or more databases to which the query instruction is provided and return results responsive to the query instruction.

At operation 412, the process 400 can include updating the alert data based on the query results. For example, the user device can update the alert data so as to include aspects of the query results in the alert data before providing the alert data to the downstream systems. In one example, the user device can filter the query results in accordance with the downstream system configured to receive the alert data and then update the alert data to include the filtered query results. The user device can then provide the alert data to the downstream system to cause the downstream system to output a representation of the alert data.

At operation 414, a GUI can be generated on the alert data. In one example, the GUI can be generated based on the alert data generated by the user device such that the GUI is configured to cause a display device of a downstream system to visually indicate the alert. In some examples, this visual indication can be represented as a report including indications of one or more network operations that are indicative of irregularities over a period of time. In some examples, the user device can generate the GUI and include the GUI in the alert data where the GUI represents the filtered information corresponding to the downstream system that is configured to receive and display the GUI. As will be understood, the user device can iteratively generate alerts for respective downstream systems targeting specific irregularities that are being monitored by the respective downstream systems.

As will be understood, the process of monitoring network operations and generating alerts has several practical applications. It optimizes performance by identifying bottlenecks and inefficiencies, detects security threats through unusual activity monitoring, and ensures compliance by tracking data flows and access controls. Real-time anomaly detection allows for immediate issue resolution, while resource management optimizes bandwidth allocation. Automated workflows triggered by irregularities streamline operations, reducing manual intervention and enhancing overall operational efficiency. These capabilities are crucial for maintaining secure, efficient, and compliant network operations.

Some embodiments of the present disclosure are described in connection with a threshold. As described herein, satisfying a threshold may refer to a value being greater than the threshold, more than the threshold, higher than the threshold, greater than or equal to the threshold, less than the threshold, fewer than the threshold, lower than the threshold, less than or equal to the threshold, equal to the threshold, and/or the like.

The above-described embodiments of the present disclosure are presented for purposes of illustration and not of limitation, and the present disclosure is limited only by the claims that follow. Furthermore, it should be noted that the features and limitations described in any one embodiment can be applied to any embodiment herein, and flowcharts or examples relating to one embodiment can be combined with any other embodiment in a suitable manner, done in different orders, or done in parallel. In addition, the systems and methods described herein can be performed in real time. It should also be noted that the systems and/or methods described above can be applied to, or used in accordance with, other systems and/or methods.

The present techniques will be better understood with reference to the following enumerated embodiments:

1. Methods for identifying network operations that are indicative of at least one cybersecurity event when monitoring network activity involving a set of network operations.

2. The method of any one of the preceding embodiments, further comprising: obtaining a dataset comprising a set of network operations, each network operation of the set of network operations occurring at a point in time within a period of time and represented by one or more attributes; determining that a subset of network operations from the set of network operations are indicative of irregularities based on the one or more attributes of each network operation; generating alert data associated with one or more alerts based on the subset of network operations that are indicative of the irregularities; determining at least one metadata element associated with the subset of network operations; generating a query instruction comprising one or more query criteria based on the at least one metadata element, the one or more query criteria corresponding to the irregularities represented by the subset of network operations; providing the query instruction to a database search system to cause the database search system to generate a set of query results in accordance with the query instruction; in response to obtaining the set of query results from the database search system, updating the alert data based on the set of query results; and generating a graphical user interface (GUI) based on the alert data, the GUI indicating at least one alert of the one or more alerts and at least one query result that corresponds to the at least one alert.

3. The method of any one of the preceding embodiments, further comprising: obtaining first user input that is indicative of a plurality of conditions associated with the irregularities; configuring a monitoring system to segment the set of network operations from a plurality of network operations executed over a network based on the plurality of conditions.

4. The method of any one of the preceding embodiments, wherein determining that the set of network operations are indicative of irregularities comprises: comparing a condition of the plurality of conditions to the one or more attributes of at least one network operation of the set of network operations; determining that the one or more attributes of the at least one network operation satisfy the condition; and determining that the at least one network operation is indicative of irregularities in response to determining that the one or more attributes of the at least one network operation satisfy the condition.

5. The method of any one of the preceding embodiments, wherein the irregularities are associated with one or more changepoints, and wherein determining that the at least one network operation is indicative of the one or more changepoints comprises: determining that the one or more attributes of the at least one network operation satisfies at least one condition from the plurality of conditions associated with the one or more changepoints.

6. The method of any one of the preceding embodiments, wherein determining that the one or more attributes of the at least one network operation satisfies the at least one condition comprises: providing the one or more attributes of the at least one network operation as input to a model to cause the model to generate an output, the output comprising at least one changepoint annotation indicating that the at least one network operation is associated with at least one changepoint; and determining that the at least one changepoint annotation satisfies the at least one condition.

7. The method of any one of the preceding embodiments, wherein the irregularities are associated with one or more anomalies, and wherein determining that the at least one network operation is indicative of the one or more anomalies comprises: determining that the one or more attributes of the at least one network operation satisfies at least one condition from the plurality of conditions associated with the one or more anomalies.

8. The method of any one of the preceding embodiments, wherein determining that the one or more attributes of the at least one network operation satisfies at least one condition comprises: providing the one or more attributes of the at least one network operation as input to a model to cause the model to generate an output, the output comprising at least one anomaly annotation indicating that the at least one network operation is associated with at least one anomaly; and determining that the at least one anomaly annotation satisfies the at least one condition.

9. The method of any one of the preceding embodiments, further comprising: obtaining second user input that is indicative of an instruction to obtain a set of metadata elements for each network operation that are indicative of the irregularities, wherein generating the query instruction comprises: generating the query instruction based on the second user input, the query instruction configured to cause the database search system to generate the set of query results to include the set of metadata elements for each network operation that are indicative of the irregularities in accordance with the one or more query criteria.

10. The method of any one of the preceding embodiments, wherein the database search system is in communication with one or more external database systems, and wherein providing the query instruction to a database search system comprises: providing the query instruction to a database search system to cause the database search system to generate one or more secondary query instructions based on the query instruction and the one or more external database systems; and causing the database search system to execute the one or more secondary query instructions to obtain the set of query results comprising the set of metadata elements for each network operation from the one or more external database systems.

11. The method of any one of the preceding embodiments, wherein causing the database search system to generate the one or more secondary query instructions comprises, for each external database system of the one or more external database systems: determining a compatibility standard associated with the one or more external database systems; and generating a secondary query instruction of the one or more secondary query instructions based on the compatibility standard associated with the one or more external database systems.

12. The method of any one of the preceding embodiments, wherein causing the database search system to generate the set of query results comprises, for each external database systems of the one or more external database systems: providing the secondary query instruction generated for the one or more external database systems to cause the one or more external database systems to generate at least a portion of the set of query results in accordance with the query instruction; and in response to receiving at least a portion of the set of query results from the one or more external database systems, updating the alert data to include at least a portion of the set of query results.

13. The method of any one of the preceding embodiments, wherein generating the GUI based on the alert data comprises, for each client device of a plurality of client devices: extracting a subset of the alert data that corresponds to a configuration of each client device; and generating the GUI at a display device of each client device based on the subset of the alert data to indicate query results from the set of query results that satisfy the configuration of each client device.

14. The method of any one of the preceding embodiments, wherein extracting the subset of the alert data comprises: determining one or more filter parameters indicated by the configuration of each client device; segmenting network operations from the set of network operations responsive to the set of query results based on the one or more filter parameters.

15. The method of any one of the preceding embodiments, wherein segmenting the network operations from the set of network operations comprises, for each network operation of the subset of network operations: determining a group of network operations corresponding to a time series represented by the set of network operations, the group of network operations comprising at least one network operation from the subset of network operations that are indicative of the irregularities and at least one additional network operation; and segmenting the group of network operations from the set of network operations.

16. One or more non-transitory, computer-readable mediums storing instructions recorded thereon that, when executed by a data processing apparatus, cause the data processing apparatus to perform operations comprising those of any of embodiments 1-15.

18. A system comprising one or more processors and memory storing instructions that, when executed by the processors, cause the processors to effectuate operations comprising those of any of embodiments 1-15.

19. A system comprising means for performing any of embodiments 1-15.

What is claimed is:

1. A system for identifying network operations that are indicative of at least one cybersecurity event when monitoring network activity involving a set of network operations, the system comprising:
one or more processors; and
one or more non-transitory, computer-readable mediums having instructions recorded thereon that, when executed by the one or more processors, cause the one or more processors to perform operations comprising:
obtaining a dataset representing a set of network operations, each network operation of the set of network operations occurring at a point in time within a period of time;
determining that a subset of network operations from the set of network operations are indicative of irregularities that are associated with at least one cybersecurity event based on attributes represented by each network operation of the subset of network operations;
generating alert data associated with one or more alerts based on the subset of network operations that are indicative of the irregularities;
determining at least one metadata element associated with the subset of network operations;
generating a query instruction associated with comprising one or more query criteria based on the at least one metadata element to obtain event data associated with the at least one cybersecurity event maintained by one or more external database systems, where the one or more external database systems are involved in monitoring network operations executed using a network;
providing the query instruction to a database search system to cause the database search system to generate a set of query results in accordance with the query instruction, the set of query results comprising the event data maintained by the one or more external database systems;
in response to obtaining the set of query results, updating the alert data based on the set of query results; and
generating a graphical user interface (GUI) based on the alert data, the GUI indicating at least one alert of the one or more alerts to indicate the at least one cybersecurity event and the set of query results corresponding to the at least one cybersecurity event.

2. A method for identifying network operations that are indicative of at least one cybersecurity event when monitoring network activity involving a set of network operations, the method comprising:
obtaining a dataset comprising a set of network operations, each network operation of the set of network operations occurring at a point in time within a period of time and represented by one or more attributes;
determining that a subset of network operations from the set of network operations are indicative of irregularities based on the one or more attributes of each network operation;
generating alert data associated with one or more alerts based on the subset of network operations that are indicative of the irregularities;
determining at least one metadata element associated with the subset of network operations;
generating a query instruction comprising one or more query criteria based on the at least one metadata element, the one or more query criteria corresponding to the irregularities represented by the subset of network operations;
providing the query instruction to a database search system to cause the database search system to generate a set of query results in accordance with the query instruction;
in response to obtaining the set of query results from the database search system, updating the alert data based on the set of query results; and
generating a graphical user interface (GUI) based on the alert data, the GUI indicating at least one alert of the one or more alerts and at least one query result that corresponds to the at least one alert.

3. The method of claim 2, further comprising:
obtaining first user input that is indicative of a plurality of conditions associated with the irregularities; and
configuring a monitoring system to segment the set of network operations from a plurality of network operations executed over a network based on the plurality of conditions.

4. The method of claim 3, wherein determining that the set of network operations are indicative of irregularities comprises:
comparing a condition of the plurality of conditions to the one or more attributes of at least one network operation of the set of network operations;
determining that the one or more attributes of the at least one network operation satisfy the condition; and
determining that the at least one network operation is indicative of irregularities in response to determining that the one or more attributes of the at least one network operation satisfy the condition.

5. The method of claim 4, wherein the irregularities are associated with one or more changepoints, and
wherein determining that the at least one network operation is indicative of the one or more changepoints comprises:
determining that the one or more attributes of the at least one network operation satisfies at least one condition from the plurality of conditions associated with the one or more changepoints.

6. The method of claim 5, wherein determining that the one or more attributes of the at least one network operation satisfies the at least one condition comprises:
providing the one or more attributes of the at least one network operation as input to a model to cause the model to generate an output, the output comprising at least one changepoint annotation indicating that the at least one network operation is associated with at least one changepoint; and
determining that the at least one changepoint annotation satisfies the at least one condition.

7. The method of claim 4, wherein the irregularities are associated with one or more anomalies, and
wherein determining that the at least one network operation is indicative of the one or more anomalies comprises:
determining that the one or more attributes of the at least one network operation satisfies at least one condition from the plurality of conditions associated with the one or more anomalies.

8. The method of claim 5, wherein determining that the one or more attributes of the at least one network operation satisfies at least one condition comprises:
providing the one or more attributes of the at least one network operation as input to a model to cause the model to generate an output, the output comprising at least one anomaly annotation indicating that the at least one network operation is associated with at least one anomaly; and
determining that the at least one anomaly annotation satisfies the at least one condition.

9. The method of claim 2, further comprising:
obtaining second user input that is indicative of an instruction to obtain a set of metadata elements for each network operation that are indicative of the irregularities, and
wherein generating the query instruction comprises:
generating the query instruction based on the second user input, the query instruction configured to cause the database search system to generate the set of query results to include the set of metadata elements for each network operation that are indicative of the irregularities in accordance with the one or more query criteria.

10. The method of claim 9, wherein the database search system is in communication with one or more external database systems, and
wherein providing the query instruction to a database search system comprises:
providing the query instruction to a database search system to cause the database search system to generate one or more secondary query instructions based on the query instruction and the one or more external database systems; and
causing the database search system to execute the one or more secondary query instructions to obtain the set of query results comprising the set of metadata elements for each network operation from the one or more external database systems.

11. The method of claim 10, wherein causing the database search system to generate the one or more secondary query instructions comprises, for each external database system of the one or more external database systems:
determining a compatibility standard associated with the one or more external database systems; and
generating a secondary query instruction of the one or more secondary query instructions based on the compatibility standard associated with the one or more external database systems.

12. The method of claim 11, wherein causing the database search system to generate the set of query results comprises, for each external database systems of the one or more external database systems:
providing the secondary query instruction generated for the one or more external database systems to cause the one or more external database systems to generate at least a portion of the set of query results in accordance with the query instruction; and
in response to receiving at least a portion of the set of query results from the one or more external database systems, updating the alert data to include at least a portion of the set of query results.

13. The method of claim 2, wherein generating the GUI based on the alert data comprises:
for each client device of a plurality of client devices:
extracting a subset of the alert data that corresponds to a configuration of each client device; and
generating the GUI at a display device of each client device based on the subset of the alert data to indicate query results from the set of query results that satisfy the configuration of each client device.

14. The method of claim 13, wherein extracting the subset of the alert data comprises:
determining one or more filter parameters indicated by the configuration of each client device; and
segmenting network operations from the set of network operations responsive to the set of query results based on the one or more filter parameters.

15. The method of claim 14, wherein segmenting the network operations from the set of network operations comprises:
for each network operation of the subset of network operations:
determining a group of network operations corresponding to a time series represented by the set of network operations, the group of network operations comprising at least one network operation from the subset of network operations that are indicative of the irregularities and at least one additional network operation; and
segmenting the group of network operations from the set of network operations.

16. One or more non-transitory, computer-readable mediums comprising instructions that, when executed by one or more processors, cause the one or more processors to perform operations comprising:
obtaining a dataset comprising a set of network operations, each network operation of the set of network operations occurring at a point in time within a period of time and represented by one or more attributes;
determining that a subset of network operations from the set of network operations are indicative of irregularities based on the one or more attributes of each network operation;
generating alert data associated with one or more alerts based on the subset of network operations that are indicative of the irregularities;
determining at least one metadata element associated with the subset of network operations;
generating a query instruction comprising one or more query criteria based on the at least one metadata element, the one or more query criteria corresponding to the irregularities represented by the subset of network operations;
providing the query instruction to a database search system to cause the database search system to generate a set of query results in accordance with the query instruction;
in response to obtaining the set of query results from the database search system, updating the alert data based on the set of query results; and
generating a graphical user interface (GUI) based on the alert data, the GUI indicating at least one alert of the one or more alerts and at least one query result that corresponds to the at least one alert.

17. The one or more non-transitory, computer-readable mediums of claim 16, wherein the instructions further cause the one or more processors to perform operations comprising:
obtaining first user input that is indicative of a plurality of conditions associated with the irregularities; and
configuring a monitoring system to segment the set of network operations from a plurality of network operations executed over a network based on the plurality of conditions.

18. The one or more non-transitory, computer-readable mediums of claim 17, wherein the instructions that cause the one or more processors determine that the set of network operations are indicative of irregularities cause the one or more processors to:
compare a condition of the plurality of conditions to the one or more attributes of at least one network operation of the set of network operations;
determine that the one or more attributes of the at least one network operation satisfy the condition; and
determine that the at least one network operation is indicative of irregularities in response to determining that the one or more attributes of the at least one network operation satisfy the condition.

19. The one or more non-transitory, computer-readable mediums of claim 18, wherein the irregularities are associated with one or more changepoints, and
wherein the instructions that cause the one or more processors to determine that the at least one network operation is indicative of the one or more changepoints cause the one or more processors to:
determine that the one or more attributes of the at least one network operation satisfies at least one condition from the plurality of conditions associated with the one or more changepoints.

20. The one or more non-transitory, computer-readable mediums of claim 19, wherein the instructions that cause the one or more processors to determine that the one or more attributes of the at least one network operation satisfies the at least one condition cause the one or more processors to:
provide the one or more attributes of the at least one network operation as input to a model to cause the model to generate an output, the output comprising at least one changepoint annotation indicating that the at least one network operation is associated with at least one changepoint; and
determine that the at least one changepoint annotation satisfies the at least one condition.
